(19) United States
(12) Patent Application Publication
(10) Pub. No.: US 2012/0311070 A1
(43) Pub. Date: Dec. 6, 2012

(54) INTELLIGENT APPLICATION ADAPTED TO MULTIPLE DEVICES

(75) Inventors: Gilles Serge BianRosa, Redwood City, CA (US); Olivier Chalouhi, Redwood City, CA (US); Christophe Jean-Claude Gillet, San Francisco, CA (US); Keith Ohlfs, Redwood City, CA (US)

(73) Assignee: FANHATTAN LLC, SAN MATEO, CA (US)

(21) Appl. No.: 13/149,181

(22) Filed: May 31, 2011

(51) Int. Cl. G06F 15/16

(52) U.S. Cl. 709/217

(57) ABSTRACT

In a method and system for accessing content, a type of device executing an application configured to access a plurality of content items is detected. The application aggregates for each content item at least one content source from which the content item may be accessed. A selection of a content item from a plurality of content items is received. A request for the content item is transmitted to a content source of the at least one content source. The request specifies a priority ordering of encoding schemes for the content item that is based on the type of device executing the application. The content item is received from the content source. The content item has an encoding scheme selected from the priority ordering of the encoding schemes.

### TECHNICAL FIELD

Example embodiments of the present application generally relate to media content, and more specifically, to a system and method for providing an application that adapts to the device executing the application.

### BACKGROUND

Applications are software programs designed to enable a user to perform a task or set of tasks. Applications are generally written for a particular platform and in a way that leverages the capabilities of that platform to satisfy a particular purpose. Certain situations may call for an application to be migrated or extended to a second platform. In these situations, the application often needs to be rewritten to conform to the development requirements of the second platform. Different application versions though may not provide the same functionality or features due to the capabilities of the devices executing the application.

### BRIEF DESCRIPTION OF DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating a network system having an architecture configured for exchanging data over a network, according to some embodiments.

FIG. 2 is a block diagram illustrating modules of an application, according to some embodiments.

FIG. 3 is a flow diagram illustrating example interaction between a client device and a network device, according to some embodiments.

FIG. 4 is a flowchart illustrating an example method of adapting features of an application based on a device executing the application, according to some embodiments.

FIG. 5 is a flowchart illustrating an example method of prioritizing encoding schemes supported by a device when requesting content, according to some embodiments.

FIG. 6 is a flowchart illustrating an example method of adapting features of an application based on a device executing the application, according to some embodiments.

FIG. 7 shows a diagrammatic representation of a machine in the example form of a computer system.

### DETAILED DESCRIPTION

Although the disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In various embodiments, a system and method to access content, a type of device executing an application configured to access a plurality of content items may be detected. The application may aggregate for each content item at least one content source from which the content item may be accessed. A selection of a content item from a plurality of content items is received. A request for the content item is transmitted to a content source of the at least one content source. The request may specify a priority ordering of encoding schemes for the content item that is based on the type of device executing the application. The content item is received from the content source. The content item has an encoding scheme selected from the priority ordering of the encoding schemes.

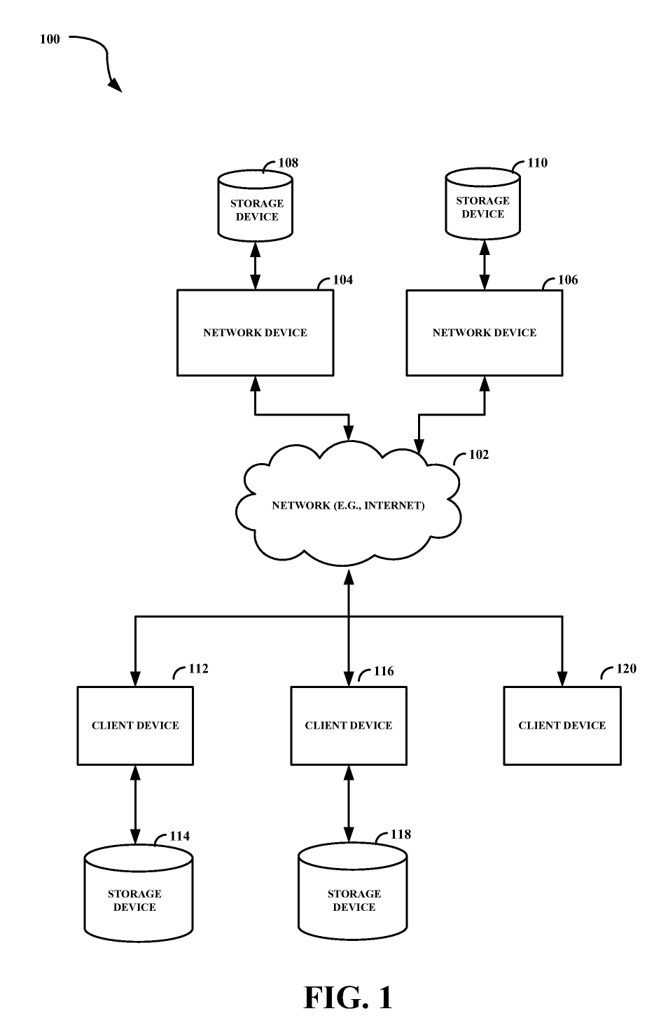

FIG. 1 is a block diagram illustrating an example network system 100 connecting one or more client devices 112, 116, and 120 to one or more network devices 104 and 106 via a network 102. The one or more client devices 112, 116, and 120 may include Internet- or network-enabled devices, such as consumer electronics devices (e.g., televisions, DVD players, Blu-Ray® players, set-top boxes, portable audio/video players, gaming consoles) and computing devices (e.g., personal computer, laptop, tablet computer, smart phone, mobile device). The type of client devices is not intended to be limiting, and the foregoing devices listed are merely examples. The client devices 112, 116, and 120 may have remote, attached, or internal storage devices 114, 118. For illustrative purposes only, although client devices 112 and 116 are shown in FIG. 1 as having connected storage devices 114 and 118, respectively, and client device 120 is shown without a connected storage device, in some embodiments, each client device 112, 116, and 120 may have local access to one or more storage or memory devices.

In some embodiments, one or more of the client devices 112, 116, and 120 may have installed thereon and may execute a client application (not shown) that enables the client device to serve as a local media server instance. The client application may search for and discover media content (e.g., audio, video, images) stored on the device as well as media content stored on other networked client devices having the client application installed thereon. The client application may aggregate the discovered media content, such that a user may access local content stored on any client device having the client application installed thereon. In some embodiments, the aggregated discovered media content may be separated by device, such that a user is aware of the network devices connected to a particular device and the content stored on the connected network devices. In some embodiments, each connected network device may be represented in the application by an indicator, such as an icon, an image, or a graphic. When a connected network device is selected, the indicator may be illuminated or highlighted to indicate that that particular network device is being accessed.

In some embodiments, the discovered media content may be stored in an aggregated data file, which may be stored on the client device. The local content may be indexed by the client device in which the content resides. The client application also may aggregate and present a variety of remote sources to the user from which the user is able to download, stream, or otherwise access a particular media content item. For example, the client application may present to the user all streaming, rental, and purchase options for a particular media content item to the extent they exist and are available for access.

One or more network devices 104 and 106 may be communicatively connected to the client devices 112, 116, and 120 via network 102. In some embodiments, the network devices 104 and 106 may be servers storing media content or metadata relating to media content available to be accessed by the client devices 112, 116, and 120. In some embodiments, the network devices 104 and 106 may include proprietary servers related to the client application as well as third party servers hosting free or subscription-based content. Additional third-party servers may include servers operating as metadata repositories and servers hosting electronic commerce sites. For example, in the context of movies, third-party servers may be servers associated with the themoviedb.org and other third-party aggregators that store and deliver movie metadata in response to user requests. In some embodiments, some of the third-party servers may host websites offering merchandise related to a content item for sale. The network devices 104 and 106 may include attached storage devices or may interface with databases or other storage devices 108 and 110. For illustrative purposes only, the network devices 104 and 106 each have been shown as a single device in FIG. 1, although it is contemplated that the network devices 104 and 106 may include one or more web servers, application servers, database servers, and so forth, operating independently or in conjunction to store and deliver content via network 102.

In some embodiments where one or more of the network devices 104 and 106 are proprietary servers associated with the client application, the proprietary servers may store metadata related to media content and data that facilitates identification of media content across multiple content servers. For example, the proprietary servers may store identifiers for media content that are used to interface with third party servers that store or host the media content. The proprietary servers further may include one or more modules capable of verifying the identity of media content and providing access information concerning media content (e.g., the source(s) of media content, the format(s) of media content, the availability of media content).

The client application installed on one or more of the client devices 112, 116, and 120 may enable a user to search for media content or navigate among categories of media content. To find media content, a user may enter search terms in a user interface of the client application to retrieve search results, or the user may select among categories and sub-categories of media content to identify a particular media content item. For each browsed content item, the client application may display metadata associated with the content item. The metadata may be retrieved from both local and remote sources. The metadata may include but are not limited to a title of the content item, one or more images (e.g., wallpapers, backgrounds, screenshots) or video clips related to the content item, a release date of the content item, a cast of the content item, one or more reviews of the content item, and release windows and release dates for various distribution channels for the browsed content item.

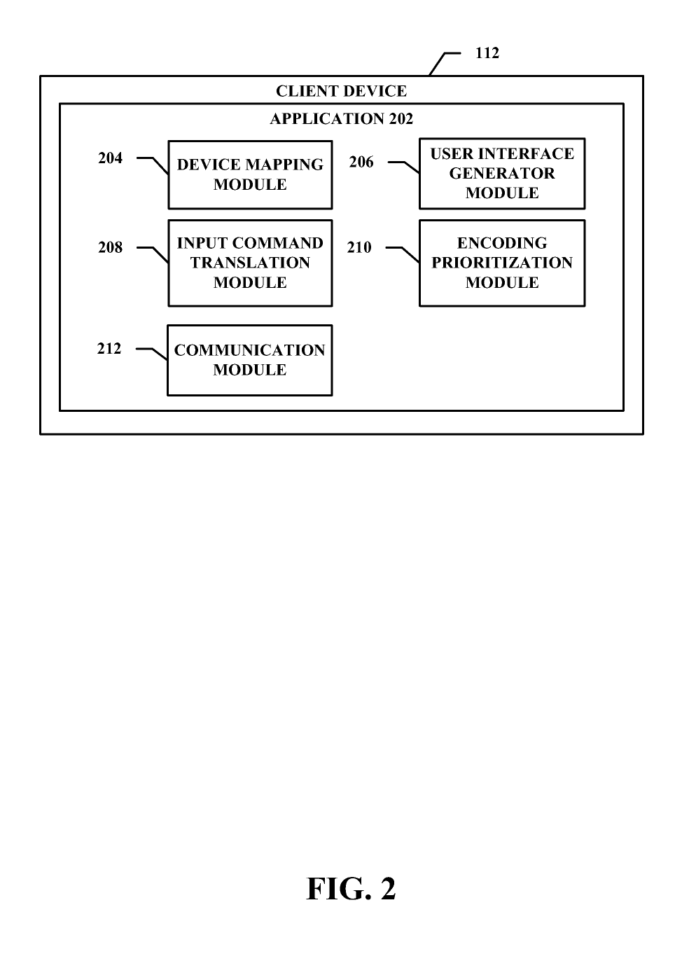

FIG. 2 is a block diagram illustrating modules of an application, according to some embodiments. Although the modules are shown in FIG. 2 as being part of a client device, it is contemplated that the modules may be implemented on a network device, such as a server. In an example embodiment, the application 202 may be the client application discussed with reference to FIG. 1. In an example embodiment, one or more processors of a client device or a network device may execute or implement the modules.

The application 202 includes modules, such as a device mapping module 204, a user interface generator module 206, an input command translator module 208, an encoding prioritization module 210, a content playback module 212, and a communication module 214 to perform operations, according to some embodiments.

The device mapping module 204 may examine a device that is executing the application 202 to determine an identity of the device, such as the type, model, and specifications of the device. In some embodiments, the device mapping module 204 may transmit a request to component of the device requesting identification of the device. In some embodiments, the device mapping module 204 may access or retrieve device identifying information. In some embodiments, the device mapping module 204 identifies a device using the device identifier (ID) of the device. The identifier or other identifying information may be received from a different component of the device or may be retrieved from a memory location. In an example embodiment in which a device identifier or other device identifying information is not received from the device components or is unavailable, the device mapping module 204 may assume that the device is a default device. For example, if a device is an analog television that lacks a device identifier or lacks the ability to respond to a request for device identifying information, the device mapping module 204 may assume that the device falls within a default category of devices.

Based on the identification of the type of device executing the application 202, the device mapping module 204 may access a data structure storing data concerning different types of devices and their respective supported capabilities and functionalities. In some embodiments, the data structure may be a device map, a table, a database, or an array, among other things. The device mapping module 204 may perform a search of the data structure using the device identification information and may retrieve corresponding device capabilities and functionalities. For example, if the device is identified as an Apple iPad® tablet computer, the device mapping module 204 may retrieve the iPad® specifications and supported functionalities from the data structure. In some embodiments, the supported functionalities may include supported encoding schemes for play back of media content, preferred encoding schemes, supported content display formats, and supported input command functionality.

The user interface generator module 206 may generate a user interface for the application that leverages the identified capabilities of the detected device. For example, based on a determination of the supported content display formats, the user interface generator module 206 may generate a user interface that takes advantage of the supported content display formats. In some embodiments, content display formats may include, but are not limited to, aspect ratio, display resolution, color depth, and frame refresh rate. For example, a detected device may support wide screen (e.g., 16:9) and standard (e.g., 4:3) aspect ratios for user interfaces. Detected devices may also support one or both of portrait and landscape viewing. Detected devices also may support high definition media content and/or standard definition media content. Detected devices may support varying levels of color depth (e.g., 16-bit, 24-bit, 30-bit, 36-bit, 48-bit). Detected devices also may support varying frame refresh rates (e.g., 60 Hz, 120 Hz, 240 Hz).

The input command translation module 208 may map application functionalities with input commands supported by the device. The application 202 may have a set of input/output functionalities that cause the application to perform certain actions. These functionalities may be mapped to input commands that are supported by the device. For example, if the application 202 is being executed on a television, the application 202 may map various application functionalities (e.g., browsing among content, selecting a content item, playing and pausing the content item) to the input commands supported by the television. In some embodiments, the television may be operated using a remote control. It is common for a remote control to have directional controls that enable navigation in the up, down, left, and right directions and selection via a selection or enter button. In some embodiments, the input command translation module 208 may map navigational or browsing application functionalities to the navigational arrow keys of a remote control and the item selection functionality to the enter or select button.

In another non-limiting example embodiment, if the application 202 is being executed on a touch-enabled device, the input command translation module 208 may map the same application functionalities (e.g., navigation actions, selection actions) to a different set of input commands supported by the touch-enabled device. For example, navigation of content in the application 202 may be accomplished via touch-based gestures, such as swipes, pinches, and multi-touch gestures. Selection of content in the application 202 may be accomplished via touch-based gestures, such as single or double taps. In some embodiments, application functionality on a touch-enabled device also may support external input/output devices, such as a stylus, a mouse, and a keyboard. The input command translation module 208 may map different input commands to the same application functionality supported on the television described in the previous example embodiment. Thus, based on the detected device type, the input command translation module 208 may map the application input/output functionality to different types of input commands.

The encoding prioritization module 210 may prioritize encoding schemes supported by a device executing an application. The encoding prioritization module 210 may communicate with the device mapping module 204 to obtain the supported encoding schemes for a detected device type. Encoding schemes may include both codecs (e.g., MPEG-1 Part 2, MPEG-2 Part 2, H.264, MPEG-4 Part 2, Windows Media Video) and multimedia containers (e.g., AVI, Flash video, MP4). Each detected device type may support different encoding schemes, and each detected device type may have a preferred encoding scheme for playing content. The encoding prioritization module 210 may prioritize the supported encoding schemes for the detected device type. The prioritized encoding schemes may be ordered such that when a request for a content item is transmitted to a content source, the request specifies that content is to be retrieved according to the highest priority encoding scheme first, if possible, and if not possible, then according to the next highest priority encoding scheme, and so forth.

In some embodiments, the encoding prioritization module 210 may prioritize the encoding schemes for a particular device based on a user-specified order. For example, the user may specify that he prefers to view MP4-formatted content first, followed by H.264-encoded content, and then MPEG-4 Part 2-encoded content. The encoding prioritization module 210 may transmit this priority order to a content source when requesting a content item.

The communication module 212 may transmit and receive communications to and from content sources and network devices. In some embodiments, the communication module 212 may transmit requests for content items based on selections input by a user to one or more content sources. The request may include a priority ordering of encoding schemes for the content item. In some embodiments, the priority ordering is obtained from the encoding prioritization module 210. In some embodiments, the priority ordering may be transmitted in the header of the request. In some embodiments, the priority ordering may be written in a manner that conforms to a syntax of a call made to the content source, for example, via an API exposed by the content source. The communication module 212 also may receive a content item from a content source. For example, the communication module 212 may receive a stream of video and audio data corresponding to the content item. The communication module 212 also may receive a file corresponding to the content item that is downloaded from a content source.

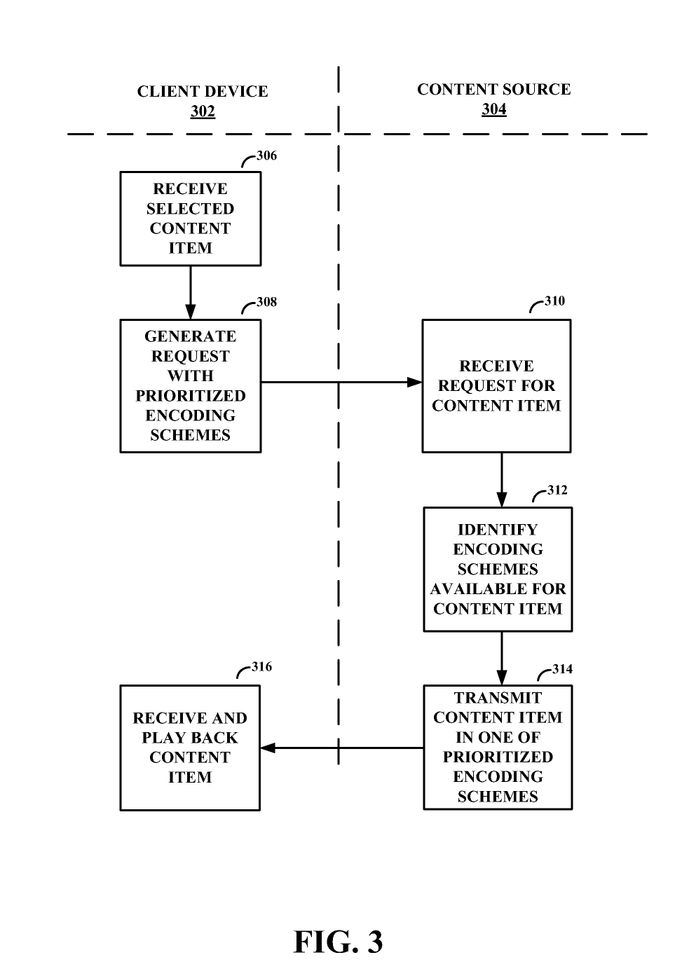

FIG. 3 is a flow diagram illustrating example interaction between a client device and a network device, according to some embodiments. Referring to FIG. 3, a client device 302 executing an application that enables users to access content may receive a selection of a content item at block 308. At block 310, the client device 302 may generate a request for the content item. The request may be sent to a content source 304 selected from one or more content sources from which the content item is available to be accessed. The request may include a priority ordering of encoding schemes for the content item. The priority ordering may specify the encoding preferences for the content item. For example, the priority ordering may specify a most preferred encoding scheme for the content item, followed by a second most preferred encoding scheme, and a least preferred encoding scheme. In some embodiments, the priority ordering may be user-specified.

At block 312, the content source 304 may receive and process the content item request sent by the content device 302. The content source 304 may compare the priority ordering of encoding schemes to the encoding schemes available for the content item and return the content item having the highest prioritized encoding scheme according to the request. At block 314, the content source 304 may transmit the content item to the client device 302. At block 316, the client device 302 may receive and play back the content item via the application.

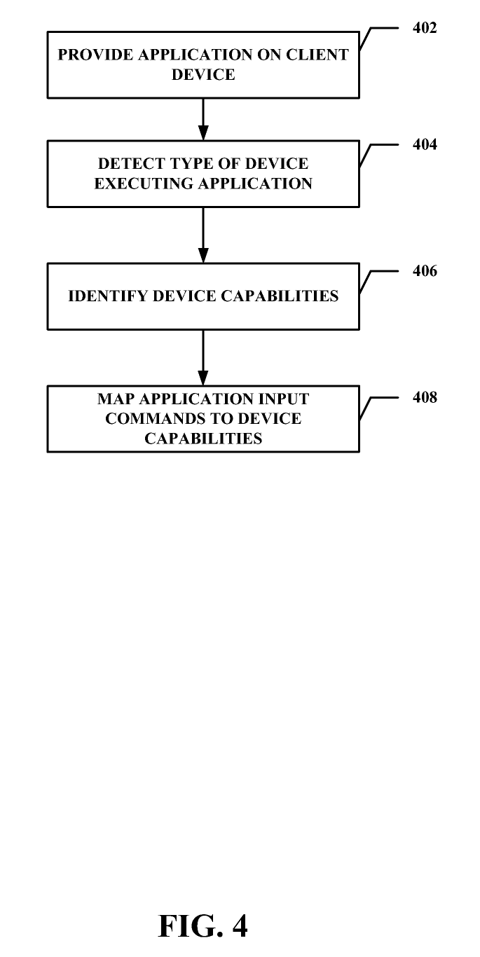

FIG. 4 is a flowchart illustrating an example method of adapting features of an application based on a device executing the application, according to some embodiments. Referring to FIG. 4, at block 402, an application that enables a user to search for and access various content items from various content sources is provided. The application may execute on a variety of devices, such as personal computers, set-top boxes, televisions, and tablet and portable computers. The application may enable a user to browse among categories of content items and specific content items. For each content item, the application may aggregate the available sources of the content item so that the user may have a fully informed view of the various channels by which the content item may be accessed or obtained.

At block 404, the application may detect a type of device executing the application. For example, the application may detect whether a television, personal computer, tablet device, DVD player, or other computing device is executing the application. The application may determine the identity of the device executing the application by retrieving a device identifier from the device. In some embodiments, the application may determine the identity of the device executing the application by transmitting an identification request to a component of the device. The component of the device receiving the request may provide device identification information, such as a device identifier. In the event the device fails to provide a response to the identification request, the application may presume the device is a default device. The default device may be considered as having a basic set of capabilities or a most commonly used set of capabilities.

At block 406, the capabilities of the detected device may be ascertained. Using the device identification information, the application may access a data structure storing a map of device types and corresponding supported capabilities and functionalities to determine the capabilities of the detected device. In some embodiments, the capabilities may include supported input/output functionality.

At block 408, the application may map application functionalities with the input/output capabilities supported by the device. For example, if the device is a television, the application may map application features to remote control input/output commands. If the device is a touch-enabled device, the application may map application features to touch-based gestures. Thus, the application may modify the mapping of the commands used to interact with the application in order to support the use of the application on different computing platforms.

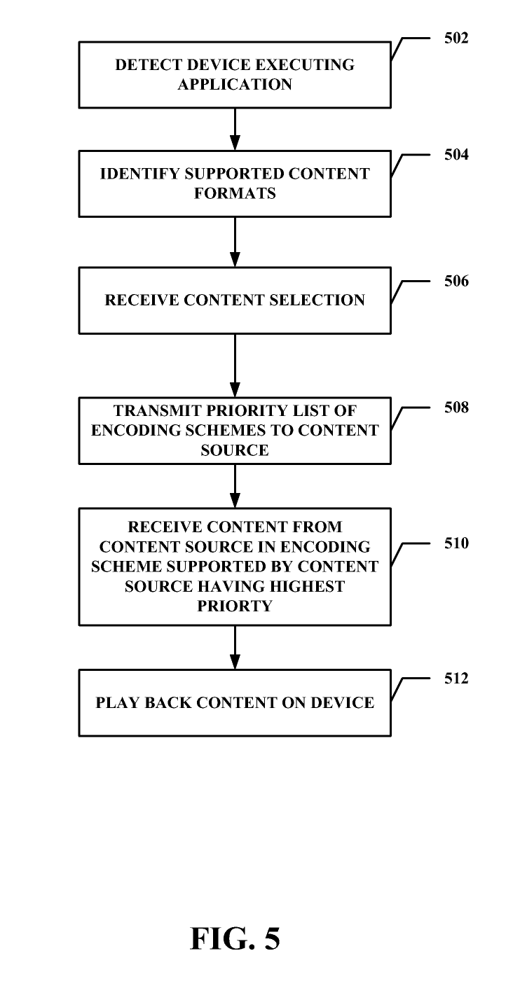

FIG. 5 is a flowchart illustrating an example method of prioritizing encoding schemes supported by a device when requesting content, according to some embodiments. Referring to FIG. 5, at block 502, the application may detect a type of device executing the application. For example, the application may detect whether a television, personal computer, tablet device, DVD player, or other computing device is executing the application. The application may determine the identity of the device executing the application by retrieving a device identifier from the device. In some embodiments, the application may determine the identity of the device executing the application by transmitting an identification request to a component of the device. The component of the device receiving the request may provide device identification information, such as a device identifier. In the event the device fails to provide a response to the identification request, the application may presume the device is a default device. The default device may be considered as having a basic set of capabilities or a most commonly used set of capabilities.

At block 504, the application may determine what content formats, including encoding schemes, are supported by the detected device type. For example, it may be determined that the device executing the application supports H.264-encoded content, but not MP4-encoded content. In some embodiments, the supported content formats may be obtained from the data structure that maps the device types to their corresponding supported functionalities. In some embodiments, the supported content formats may be prioritized in an order of most preferred content format to least preferred content format.

At block 506, a content selection is received from a user. The content selection may include the selection of a content source from which to access the content item.

At block 508, a request for the content item is transmitted by the device executing the application to the selected content source. The request may include a priority ordering of encoding schemes for the content item. In some embodiments, the priority ordering may be included in the header of the request, although in other embodiments, the priority ordering may be included in a different portion of the request.

At block 510, the content item may be received from the content source. The content item returned may be encoded according to the encoding format having the highest priority ordering available at the content source. In other words, the content source may determine which encoding schemes are available for the content item and may return the content item encoded according to the encoding scheme having the highest available priority.

At block 512, the content item may be played back on the device via the application.

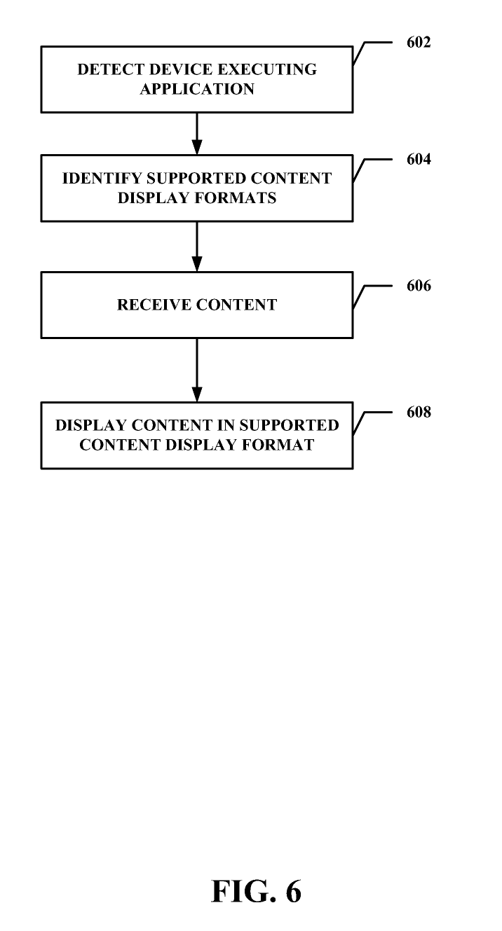

FIG. 6 is a flowchart illustrating an example method of adapting features of an application based on a device executing the application, according to some embodiments. Referring to FIG. 6, at block 602, the application may detect a type of device executing the application. For example, the application may detect whether a television, personal computer, tablet device, DVD player, or other computing device is executing the application. The application may determine the identity of the device executing the application by retrieving a device identifier from the device. In some embodiments, the application may determine the identity of the device executing the application by transmitting an identification request to a component of the device. The component of the device receiving the request may provide device identification information, such as a device identifier. In the event the device fails to provide a response to the identification request, the application may presume the device is a default device. The default device may be considered as having a basic set of capabilities or a most commonly used set of capabilities.

At block 604, the application may determine what content display formats are supported by the detected device type. Content display formats may include aspect ratio, display resolution, color depth, and frame refresh rate. For example, it may be determined that the device executing the application supports both portrait and landscape views, high definition video, and a 120 Hz refresh rate. In some embodiments, the supported content display formats may be obtained from the data structure that maps the device types to their corresponding supported functionalities.

At block 606, the application may receive content from a content source in response to a request sent to the content source for access to a content item.

At block 608, the application may display the content according to content display formats supported by the device. In some embodiments, if multiple content display formats (e.g., standard definition and high definition video) are supported by the device, the application may display the content in the content display format capable of displaying the content item in the highest possible quality. In other embodiments, content display formats may be selected based on the available resources of the device or based on ensuring that play back of the content item proceeds smoothly.

### Modules, Components and Logic

Certain embodiments are described herein as including logic or a number of components, modules, or mechanisms. A component or module is a non-transitory and tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module also may comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components at different times. Software may accordingly configure a processor, for example, to constitute a particular component or module at one instance of time and to constitute a different component or module at a different instance of time.

Components or modules can provide information to, and receive information from, other components or modules. Accordingly, the described components may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation, and store the output of that operation in a memory device to which it is communicatively coupled. A further component or module may then, at a later time, access the memory device to retrieve and process the stored output. Components or modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

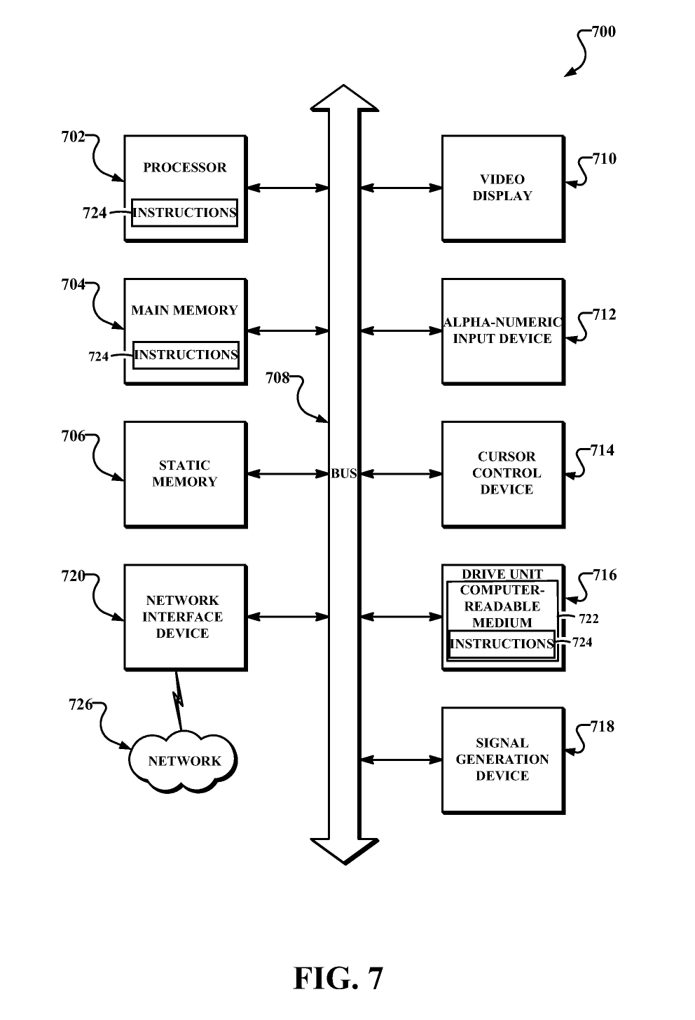

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes at least one processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any non-transitory tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 724 may further be transmitted or received over a communications network 726 using a transmission medium. The software 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Example Three-Tier Software Architecture

In some embodiments, the described methods may be implemented using one a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third storage tier may be a persistent storage medium or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, distributed or so some other suitable configuration. Further, these three tiers may be distributed between more than one computer systems as various components.

### Components

Example embodiments may include the above described tiers, and processes or operations about constituting these tiers may be implemented as components. Common to many of these components is the ability to generate, use, and manipulate data. The components, and the functionality associated with each, may form part of standalone, client, or server computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server and/or client software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an Internet, Local Area Network (LAN), Wide Area Network (WAN), or some other suitable network. In some cases, Internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, comprising:
detecting a type of device executing an application configured to access a plurality of content items, the application aggregating for each content item at least one content source from which the content item may be accessed;
receiving a selection of a content item from the plurality of content items;
transmitting a request to access the content item to a content source of the at least one content source, the request specifying a priority ordering of encoding schemes for the content item, the priority ordering of the encoding schemes based on the detected type of device executing the application; and
receiving the content item from the content source, the content item having an encoding scheme selected based on the priority ordering of the encoding schemes.

2. The method of claim 1, wherein the detecting of the type of device comprises:
transmitting an identification request to the device;
based on receiving an identification response from the device, determining the type of the device executing the application; and
based on not receiving an identification response from the device, assuming a default device as the type of device executing the application.

3. The method of claim 1, further comprising:
comparing the detected device type to a data structure storing supported device type capabilities; and
based on a comparison match, determining the supported device type capabilities for the detected device type,
wherein the supported device type capabilities include the encoding schemes supported by the device.

4. The method of claim 1, wherein the priority ordering of the encoding schemes for the content item are specified by a user based on encoding schemes supported by the device type.

5. The method of claim 3, wherein the priority ordering of the encoding schemes for the content item are retrieved from the data structure storing the supported device type capabilities.

6. The method of claim 1, further comprising:
comparing the detected device type to a data structure storing supported device type capabilities; and
based on a comparison match, determining the supported device type capabilities for the detected device type,
wherein the supported device type capabilities include content display formats supported by the device.

7. The method of claim 6, wherein the content display formats include at least one of aspect ratio, display resolution, color depth, and frame refresh rate.

8. The method of claim 1, further comprising:
comparing the detected device type to a data structure storing supported device type capabilities; and
based on a comparison match, determining the supported device type capabilities for the detected device type,
wherein the supported device type capabilities include input commands supported by the device.

9. The method of claim 8, wherein the input commands include at least one of touch gestures, commands received from an input/output device, and commands received from a remote control device.

10. A machine-readable storage medium storing a set of instructions that, when executed by at least one processor, causes the at least one processor to perform operations comprising:
detecting a type of device executing an application configured to access a plurality of content items, the application aggregating for each content item at least one content source from which the content item may be accessed;
receiving a selection of a content item from the plurality of content items;
transmitting a request to access the content item to a content source of the at least one content source, the request specifying a priority ordering of encoding schemes for the content item, the priority ordering of the encoding schemes based on the detected type of device executing the application; and
receiving the content item from the content source, the content item having an encoding scheme selected based on the priority ordering of the encoding schemes.

11. The machine-readable storage medium of claim 10, wherein the detecting of the type of device comprises:
transmitting an identification request to the device;
based on receiving an identification response from the device, determining the type of the device executing the application; and
based on not receiving an identification response from the device, assuming a default device as the type of device executing the application.

12. The machine-readable storage medium of claim 10, further comprising:
comparing the detected device type to a data structure storing supported device type capabilities; and
based on a comparison match, determining the supported device type capabilities for the detected device type,
wherein the supported device type capabilities include the encoding schemes supported by the device.

13. The machine-readable storage medium of claim 10, wherein the priority ordering of the encoding schemes for the content item are specified by a user based on encoding schemes supported by the device type.

14. The machine-readable storage medium of claim 12, wherein the priority ordering of the encoding schemes for the content item are retrieved from the data structure storing the supported device type capabilities.

15. The machine-readable storage medium of claim 10, further comprising:
comparing the detected device type to a data structure storing supported device type capabilities; and
based on a comparison match, determining the supported device type capabilities for the detected device type,
wherein the supported device type capabilities include content display formats supported by the device.

16. The machine-readable storage medium of claim 15, wherein the content display formats include at least one of aspect ratio, display resolution, color depth, and frame refresh rate.

17. The machine-readable storage medium of claim 10, further comprising:
comparing the detected device type to a data structure storing supported device type capabilities; and
based on a comparison match, determining the supported device type capabilities for the detected device type,
wherein the supported device type capabilities include input commands supported by the device.

18. The machine-readable storage medium of claim 17, wherein the input commands include at least one of touch gestures, commands received from an input/output device, and commands received from a remote control device.

19. A system, comprising:
a processor-implemented device mapping module configured to detect a type of device executing an application configured to access a plurality of content items, the application aggregating for each content item at least one content source from which the content item may be accessed;
a processor-implemented encoding prioritization module configured to prioritize an order of encoding schemes for a content item of the plurality of content items, the priority order of the encoding schemes based on the detected type of device executing the application; and
a processor-implemented communication module configured to:
transmit a request to access the content item to a content source of the least one content source, the request specifying the priority order of the encoding schemes for the content item; and
receive the content item from the content source, the received content item having an encoding scheme selected based on the priority ordering of the encoding schemes.

20. The system of claim 19, wherein the processor-implemented device mapping module is configured to detect the type of device executing the application by:
transmitting an identification request to the device;
based on receiving an identification response from the device, determining the type of the device executing the application; and
based on not receiving an identification response from the device, assuming a default device as the type of device executing the application.

21. The system of claim 19, wherein the processor-implemented device mapping module is further configured to:
compare the detected device type to a data structure storing supported device type capabilities; and
based on a comparison match, determine the supported device type capabilities for the detected device type,
wherein the supported device type capabilities include the encoding schemes supported by the device.

22. The system of claim 21, wherein the priority ordering of the encoding schemes for the content item are specified by a user based on encoding schemes supported by the device type.

23. The system of claim 19, wherein the processor-implemented device mapping module is further configured to:
compare the detected device type to a data structure storing supported device type capabilities; and
based on a comparison match, determine the supported device type capabilities for the detected device type,
wherein the supported device type capabilities include content display formats supported by the device.

24. The system of claim 23, further comprising a processor-implemented user interface generator module configured to generate a user interface for the application based on the content display formats supported by the device,
wherein the content display formats include at least one of aspect ratio, display resolution, color depth, and frame refresh rate.

25. The system of claim 19, wherein the processor-implemented device mapping module is further configured to:
compare the detected device type to a data structure storing supported device type capabilities; and
based on a comparison match, determine the supported device type capabilities for the detected device type,
wherein the supported device type capabilities include input commands supported by the device.

26. The system of claim 25, further comprising a processor-implemented input translation command module configured to map application command functionalities to the input commands supported by the device,
wherein the input commands include at least one of touch gestures, commands received from an input/output device, and commands received from a remote control device.
